(19) United States
(12) Patent Application Publication
(10) Pub. No.: US 2018/0259011 A1
(43) Pub. Date: Sep. 13, 2018

(54) SPRAG ONE-WAY CLUTCH

(71) Applicant: NTN CORPORATION, Osaka-shi, Osaka (JP)

(72) Inventor: Rino FUKAMI, Shizuoka (JP)

(73) Assignee: NTN Corporation, Osaka-shi, Osaka (JP)

(21) Appl. No.: 15/758,206

(22) PCT Filed: Sep. 9, 2016
(86) PCT No.: PCT/JP2016/076664

§ 371 Date: Mar. 7, 2018

(30) Foreign Application Priority Data
Sep. 10, 2015 (JP) 2015-178538

(51) Int. Cl. F16D 41/07

(52) U.S. Cl. CPC F16D 41/07; F16D 2041/0603

(57) ABSTRACT

Two sprag one-way clutch retainers each include sprag-receiving pockets for receiving sprags which are arranged along a circumferential direction and are equal in number to the sprags, and dummy pockets in the form of holes having both radially outer and inner ends open and arranged between the respective circumferentially adjacent pairs of the sprag-receiving pockets. One of the two retainers is an outer retainer positioned in a radially outer portion of the annular space of the sprag one-way clutch, and the other of the two retainers is an inner retainer positioned in a radially inner portion of the annular space. Each retainer has a junction formed by joining together two circumferential ends of a strip member to form the retainer.

### TECHNICAL FIELD

This invention relates to a sprag one-way clutch that uses sprags as engaging elements.

### BACKGROUND ART

A synchronous sprag one-way clutch includes an inner ring and an outer ring that rotate relative to each other, and sprags as engaging elements disposed between the inner ring and the outer ring, and configured such that their attitudes change according to the rotational directions of the inner ring and the outer ring, thereby selectively allowing and prohibiting relative rotation between the inner ring and the outer ring.

A one-way clutch of this type includes a pair of ring-shaped outer retainer and inner retainer, and these retainers include pockets for receiving the sprags which pockets are arranged at a predetermined pitch along the circumferential direction at regular intervals. The pockets receive sprags having a gourd-shaped cross-section.

Each sprag has an outer ring-side cam surface and an inner ring-side cam surface each having a single radius of curvature radius or a plurality of radii of curvature. The outer ring-side cam surface engages with the inner peripheral raceway surface of the outer ring and the inner ring-side cam surface engages with the outer peripheral raceway surface of the inner ring.

Disposed between the outer retainer and the inner retainer of the synchronous sprag one-way clutch is a ribbon spring as an elastic member for biasing the sprags. The ribbon spring has sprag-receiving holes in which the sprags are inserted so that the sprags are retained at centers in the width direction of the ribbon spring.

The ribbon spring has tongues for retaining the sprags. The tongues of the ribbon spring always apply a moment to the sprags in a predetermined direction. The ribbon spring is an elongated thin sheet, which is, after inserting the sprags into the sprag-receiving holes, bent into a ring shape until its ends abut each other, and inserted between the outer retainer and the inner retainer.

The below-identified Patent Document 1 proposes a retainer obtained by annularly bending a strip member having pockets for receiving sprags at predetermined intervals, and connecting its ends together. The pockets are through holes that extend through the strip member from its front to back. The below-identified Patent Document 2 proposes to form a retainer from a fiber-reinforced plastic to reduce its weight and cost. The below-identified Patent Document 3 discloses a retainer in which cutoff portions are formed in portions of annular sections on both sides of the respective pockets retaining the sprags, to reduce the axial relative movement between the opposed ends.

### PRIOR ART DOCUMENTS

### Patent Documents

Patent Document 1: Japanese Registered Utility Model No. 2580650
Patent Document 2: Japanese Patent Publication No. 2002-139080A
Patent Document 3: Japanese Patent Publication No. 8-277856A

### SUMMARY OF THE INVENTION

### Object of the Invention

In a sprag one-way clutch, the number of sprags determines the acceptable load torque. Accordingly, by inserting only the required minimum number of sprags depending on the load torque, i.e., without inserting sprags more than necessary, reductions in the weight and the cost are possible. As disclosed in Patent Documents 1 to 3, the number of pockets of the retainer or the number of sprag-receiving holes of the ribbon spring is equal to the number of sprags disposed between the inner ring and the outer ring.

For example, as a material of a retainer or an elastic member for biasing the sprags, a metal strip (strip member) is adopted, the strip member is bent into an annular shape, its both ends are connected together, and the connected portion of the strip member is fixed by welding so that the retainer can be produced at low cost.

However, in the retainer, if the number of sprags is small, the distances between the respective adjacent pairs of pockets become long. Thus, there is a problem that the rigidity of the strip member is partially high. If the rigidity of the strip member is too high, it is difficult to form the strip member into a perfectly circular shape by bending, and instead the retainer tends to have a distorted circular shape such as a polygonal shape.

If the outer retainer does not have the perfect circular shape, for example, frictional engagement with the outer ring inner diameter portion is not stable, or contact positions with the sprags are not stable, so that it is possible that the behaviors of the sprags becomes unstable.

The same applies to the elastic member for biasing the sprag, and if the number of sprags is small, the distances between the respective adjacent pairs of sprag-receiving holes becomes long. Accordingly, the rigidity of the strip member is partially high. This makes it difficult to form the strip member into a perfect circular shape, and instead, the elastic member tends to have a distorted circular shape such as a polygonal shape.

If the elastic member for biasing the sprags does not have the perfect circular shape, frictional engagement with the outer retainer or the inner retainer is not stable, or variations are caused in biasing forces to the sprags, so that it is possible that the behaviors of the sprags are not stable.

According to this invention, the retainer or the elastic member for biasing the sprags used for the sprag one-way clutch is formed to have the perfect circular shape.

### Means for Achieving the Object

In order to achieve this object, the present invention provides a retainer for use in a one-way clutch comprising sprags disposed in an annular space between an outer ring and an inner ring, wherein the retainer has sprag-receiving pockets arranged along a circumferential direction, and configured to receive the sprags, the sprag-receiving pockets being equal in number to the number of the sprags; and dummy pockets comprising holes that are each open at radially outer and radially inner ends thereof, and disposed between respective circumferentially adjacent pairs of the sprag-receiving pockets.

From another aspect of the invention, the present invention provides a combination of two retainers each comprising the above-mentioned retainer, wherein one of the two retainers is an outer retainer positioned in a radially outer portion of the annular space, and the other of the two retainers is an inner retainer positioned in a radially inner portion of the annular space.

The retainer or each of the two retainers may have a junction formed by joining together two circumferential ends of a strip member to form the retainer.

The dummy pockets may have areas smaller than the areas of the sprag-receiving pockets.

A sprag one-way clutch including the above-mentioned retainer or two retainers may be used in a torque converter of an automatic transmission.

From another aspect of the invention, the present invention provides an elastic member for use in a one-way clutch comprising sprags disposed in an annular space between an outer ring and an inner ring, the elastic member being configured to bias the sprags, wherein the elastic member has sprag-receiving holes arranged along a circumferential direction, and configured to receive the sprags, the sprag-receiving holes being equal in number to the number of the sprags; and dummy sprag-receiving holes comprising holes that are each open at radially outer and radially inner ends thereof, and disposed between respective circumferentially adjacent pairs of the sprag-receiving holes.

The dummy sprag-receiving holes may have areas smaller than the areas of the sprag-receiving holes.

A sprag one-way clutch including the above-mentioned elastic member may be used in a torque converter of an automatic transmission.

### Advantageous Effects of Invention

According to this invention, in the retainer, dummy pockets that do not receive sprags are disposed between the respective adjacent pairs of the pockets that receive the sprags, and thus, even if the number of sprags is small, partial sites having too high rigidity are not likely to be caused to the retainer. Accordingly, the retainer can be easily and accurately produced to have a perfect circle shape. Further, by providing the dummy pockets, the weight of the retainer is reduced and oil permeability of each of the pockets is improved.

Further, according to this invention, in the elastic member for biasing the sprags, between the respective adjacent pairs of the sprag-receiving holes that receive the sprags, dummy sprag-receiving holes that does not receive sprags is provided, and thus, even if the number of the sprags is small, partial sites having too high rigidity are not likely to be caused to the elastic member. Accordingly, the elastic member for biasing the sprags can be easily and accurately produced to have a perfect circle shape. Further, by providing the dummy sprag-receiving holes, the weight of the elastic member for biasing the sprags is reduced, and oil permeability of each of the sprag house holes is improved.

### BRIEF DESCRIPTION OF THE DRAWINGS

FIG. 1A is an overall front view of a one-way clutch according to one embodiment of this invention.

FIG. 1B is a partial enlarged view of the one-way clutch of FIG. 1A.

FIG. 2A is a perspective view of an outer retainer.

FIG. 2B is a perspective view of an inner retainer.

FIG. 3A is a plan view of a ribbon spring before being bent into a ring shape.

FIG. 3B is a perspective view of a sprag.

### MODE FOR CARRYING OUT THE INVENTION

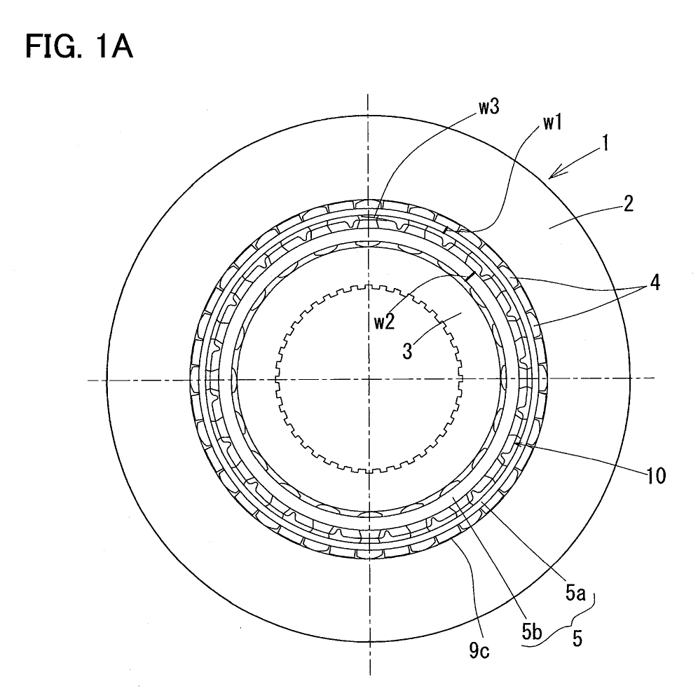

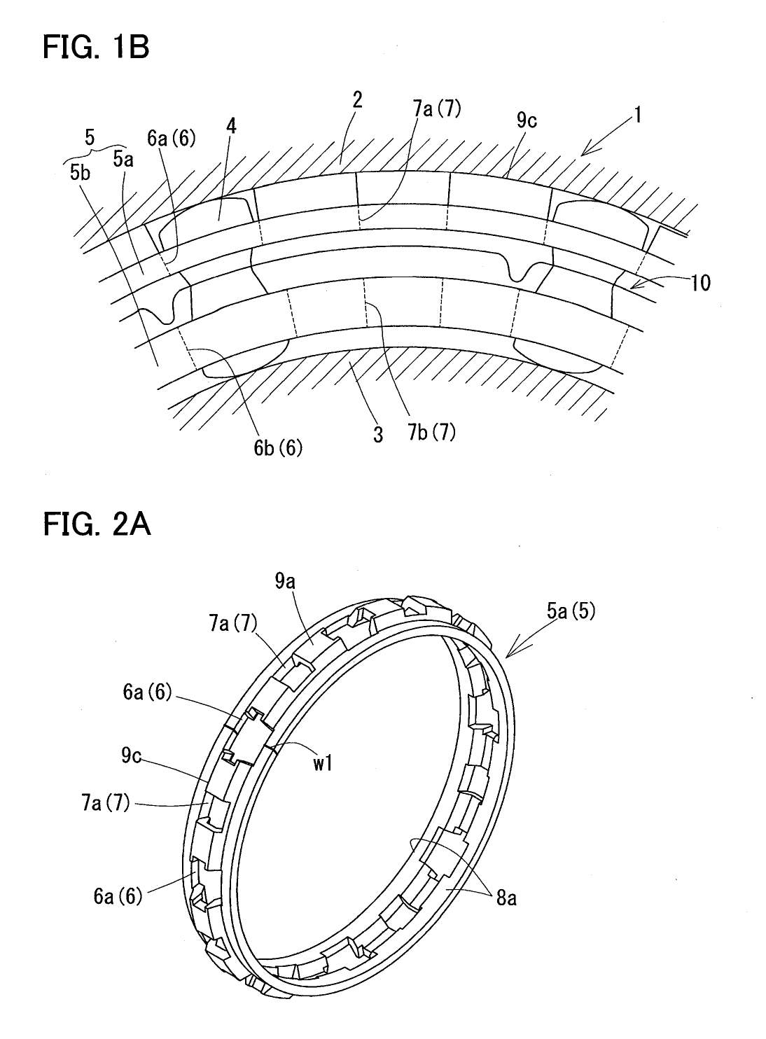

Embodiments of this invention are described below with reference to the drawings. As illustrated in FIG. 1A and FIG. 1B, a sprag one-way clutch 1 (hereinafter simply referred to as “clutch 1”) according to the present embodiment includes an outer ring 2 with an inner peripheral raceway surface, an inner ring 3 disposed within the outer ring 2 and includes an outer peripheral raceway surface, and sprags 4 that are disposed between the outer ring 2 and the inner ring 3 and configured to transfer torque between the outer circumferential raceway surface and the inner circumferential raceway surface.

The clutch 1 includes retainers 5 keeping the sprags 4 circumferentially arranged at equal intervals, and a ribbon spring 10, as a sprag-biasing elastic member, disposed between the inner ring 3 and the outer ring 2, and biasing the sprags 4 in a direction in which the sprags 4 engages with the outer peripheral raceway surface and the inner peripheral raceway surface.

The retainers 5 of the clutch 1 of this embodiment comprise an outer retainer 5a located closer to the outer ring 2 and an inner retainer 5b located closer to the inner ring 3, with the ribbon spring 10 disposed between the outer retainer 5a and the inner retainer 5b. Such a clutch is known as a synchronous sprag one-way clutch. The clutch is mainly used for a torque converter of an automatic transmission such as in an automobile, but can also be used for various other purposes.

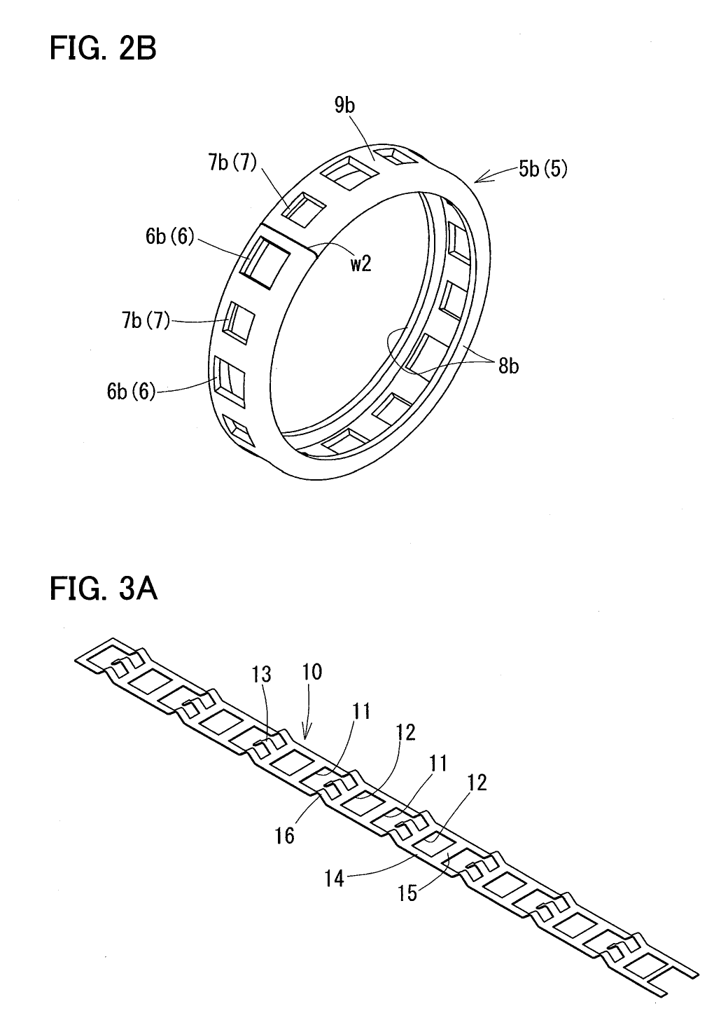

The outer retainer 5a is an annular member made of e.g., a resin or a metal. In this embodiment, as illustrated in FIG. 2A, the outer retainer 5a is an annular member (ring-shaped member) formed by bending a metal strip into a ring shape, and welding together the ends of the strip along a junction w1. Such an outer retainer 5a can be manufactured at a low cost.

The outer retainer 5a includes a pair of annular end portions 8a which are aligned with each other in the axial direction of the clutch 1. The annular end portions 8a are longitudinally extending portions of the metal strip before being formed into the annular outer retainer member 5a by welding its ends together along the junction w1. The outer retainer 5a further includes pillars 9a arranged, between the annular end portions 8a, at regular intervals in the circumferential direction of the clutch 1, around the center axis of the clutch 1, and connecting the annular end portions 8a together.

The spaces between the respective circumferentially adjacent pairs of pillars 9a are radially extending spaces which are open both at the radially inner and outer ends thereof. The sprags 4 are received in some of these spaces, and these spaces are hereinafter referred to as “sprag-receiving pockets 6a”, and the other spaces, i.e., the spaces in which the sprags 4 are not received, are hereinafter referred to as “dummy pockets 7a”.

The pillars 9a have, at the centers thereof in the axial direction of the clutch, radially outwardly extending protrusions 9c such that the circle that passes through the maximum-diameter portions of the pillars 9a has a diameter slightly larger than the inner diameter of the outer ring 2.

The sprag-receiving pockets 6a are disposed at equal intervals in the circumferential direction and the number of the pockets 6a is equal to the number of the sprags 4. In the embodiment, one of the dummy pockets 7a is disposed between each circumferentially adjacent pair of the sprag-receiving pockets 6a, but more than one of the dummy pockets 7a may be disposed between each circumferentially adjacent pair of the pockets 6a.

The inner retainer member 5b is, as with the outer retainer member 5a, an annular member made of e.g., a resin or a metal. In this embodiment, as illustrated in FIG. 2B, the inner retainer 5b is an annular member (ring-shaped member) formed by bending a metal strip into a ring shape, and welding its ends together along a junction w2. Such an inner retainer 5b can be manufactured at a low cost.

The inner retainer 5b includes a pair of annular end portions 8b which are aligned with each other in the axial direction of the clutch 1. The annular end portions 8b are longitudinally extending portions of the metal strip before being formed into the annular inner retainer 5b by welding its ends together along the junction w2. The inner retainer 5b further includes pillars 9b arranged, between the annular end portions 8b, at regular intervals in the circumferential direction of the clutch 1, around the center axis of the clutch 1, and connecting the annular end portions 8b together.

The spaces between the respective circumferentially adjacent pairs of pillars 9b are radially extending spaces which are open both at the radially inner and outer ends thereof. The sprags 4 are received in some of these spaces, and these spaces are hereinafter referred to as “sprag-receiving pockets 6b”, and the other spaces, i.e., the spaces in which the sprags 4 are not received, are hereinafter referred to as “dummy pockets 7b”.

The sprag-receiving pockets 6b are disposed at equal intervals in the circumferential direction and the number of the pockets 6b is equal to the number of the sprags 4. In the embodiment, one of the dummy pockets 7b is disposed between each circumferentially adjacent pair of the sprag-receiving pockets 6b, but more than one of the dummy pockets 7b may be disposed between each circumferentially adjacent pair of the pockets 6b.

Either of the junction w1 of the outer retainer 5a and the junction w2 of the inner retainer 5b may be defined along a straight line extending in the axial direction from one to the other of the annular end portions 8a (8b), or may include portions defined in the respective annular end portions 8a (8b) and circumferentially displaced from each other. In the latter arrangement, the junction w1 (w2) may include a portion that extends across one of the pillars 9a (9b).

Each of the retainers 5 of this embodiment uses an elongated member obtained by pressing and punching a thin metal sheet, and as described above, the elongated member is formed into a ring shape. The retainers may be formed from elongated members made of a material other than a metal.

When the retainers 5 are made of metal, the junctions w1 and w2 can be formed by e.g., welding or adhesive bonding. In this embodiment, the retainers 5 are made of metal, and thus, the junctions w1, w2 are formed by welding.

The dummy pockets 7 (7a, 7b) are holes/openings having sectional areas smaller than the sectional areas of the sprag-receiving pockets 6 (6a, 6b). Since the dummy pockets 7 (7a, 7b) are not intended to receive the sprags 4, in this embodiment, the dummy pockets 7 (7a, 7b) are small to such an extent that the sprags 4 cannot be inserted.

Since the dummy pockets 7 (7a, 7b) are small enough to not receive the sprags 4, when the ribbon spring 10 is fitted to the retainers 5 (5a, 5b) with the sprags 4 inserted in the ribbon spring 10, the sprags 4 are prevented from erroneously entering the dummy pockets 7 (7a, 7b), so that it is possible to reliably fit the sprags 4 into the respective predetermined pockets 6 (6a, 6b).

The dummy pockets 7 (7a, 7b) reduce variations in rigidity of the retainers over the entire circumference thereof, make it easier to manufacture the retainers 5 (5a, 5b), and reduce the weight and cost of the retainer.

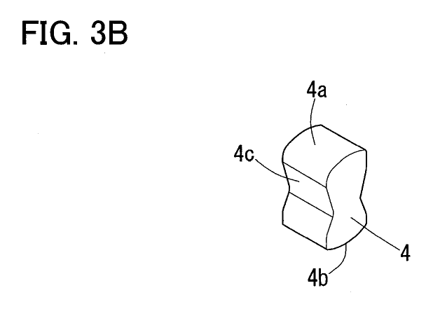

To bias the sprags 4 in a direction in which the sprags 4 engage with the inner ring 3 and the outer ring 2, the ribbon spring 10 is disposed to extend along the radially inner surface of the outer retainer 5a. The ribbon spring 10 is, as with the retainers 5, formed from a ladder-shaped strip, and includes, as illustrated in FIG. 3A, a pair of longitudinal members 14 that are aligned with each other in the axial direction of the clutch 1, and pillars 15 arranged at regular intervals in the circumferential direction around the center axis, and connecting the longitudinal members 14 (which are hereinafter referred to as the “annular sections 14”) together.

As illustrated in FIG. 3B, each sprag 4 has, on the outer diameter side, a cam surface 4a, i.e., a surface for engaging with the outer ring 2 and at the inner diameter side, a cam surface 4b, i.e., a surface for engaging with the inner ring 3.

The ribbon spring 10 is annularly formed using, for example, a resin or a metal. The ribbon spring 10 of this embodiment uses an elongated member obtained by pressing and punching a thin metal sheet, and the elongated member is formed into a ring shape as described above. However, if there is no problem in terms of manufacturing process and strength, the ribbon spring may be formed from an elongated member made of a material other than a metal.

The spaces between the respective circumferentially adjacent pairs of pillars 15 are radially extending holes which are open both at the radially inner and outer ends thereof. The sprags 4 are received in some of these spaces, and these spaces are hereinafter referred to as “sprag-receiving holes 11”, and the other spaces, i.e., the spaces in which the sprags 4 are not received, are hereinafter referred to as “dummy sprag-receiving holes 12”.

Each annular section 14 has corrugations 16 each located at the center of the portion of the annular section 14 adjacent to a respective sprag-receiving hole 11, i.e., the portion of the annular section 14 between the pillars 15 defining the respective sprag-receiving hole 11 such that the corrugations 16 are bent radially inwardly when the ribbon spring 10 is formed into a ring shape. The corrugations 16 increase the rigidity of the portions of the ribbon spring 10 where there are the corrugations 16.

Each sprag-receiving hole 11 includes a tongue 13 that protrudes from the pillar 15 defining one end of the sprag-receiving hole 11 toward the other end of the sprag-receiving hole 11. The tongue 13 protrudes from the pillar 15 into the sprag-receiving hole 11, and contacts one side 4c of the corresponding sprag 4, thereby biasing the sprag 4 in the direction in which the sprag 4 engages with the outer ring 2 and the inner ring 3.

The sprag-receiving holes 11 are arranged at equal intervals in the circumferential direction, and the number of the sprag-receiving holes 11 is the same as the number of the sprags 4. Each of the dummy sprag housing holes 12 is disposed between a respective circumferentially adjacent pair of the sprag-receiving holes 11. The number of dummy sprag-receiving holes disposed between each circumferentially adjacent pair of the sprag-receiving holes 11 may be one, as in this embodiment, or may be two or more.

The ribbon spring 10 includes a connection w3 obtained by abutting or superposing the circumferential ends of the strip member.

When the ribbon spring 10 is made of metal, the connection w3 can be formed through the joining such as welding or adhesive bonding, but in this embodiment, the connection w3 of the ribbon spring 10 is not formed through the joining such as welding or adhesive bonding, and the ribbon spring is formed into an annular member by superposing one end on the other.

The dummy sprag-receiving holes 12 have sectional areas smaller than the sectional areas of the sprag-receiving holes 11. Further, since the dummy sprag-receiving holes 12 are not intended to receive the sprags 4, in this embodiment, the dummy sprag-receiving holes 12 are small to such an extent that the sprags 4 cannot be inserted.

Since the dummy sprag-receiving holes 12 are small enough to not receive the sprags 4, the sprags 4 are prevented from erroneously entering the dummy sprag-receiving holes 12, so that it is possible to reliably fit the sprags 4 into the predetermined sprag-receiving holes 11.

The dummy sprag-receiving pockets 12 reduce variations in rigidity of the ribbon spring 10 over the entire circumference thereof, make it easier to manufacture the ribbon spring 10, and reduce the weight and cost of the ribbon spring 10.

While the clutch 1 of this embodiment is a sprag one-way clutch including two retainers 5, i.e., an outer retainer 5a disposed closer to the outer ring 2, and an inner retainer 5b disposed closer to the inner ring 3, the present invention is applicable to a sprag one-way clutch including only one of the outer retainer 5a and the inner retainer 5b

In the clutch 1 of this embodiment, each retainer 5 is formed by bending a strip member into an annular shape, and joining its ends together, but even when retainers 5 that are annularly molded in advance using a metal or a resin are used, certain effects can be expected by including the dummy pockets 7.

In the clutch 1 of this embodiment, as means for biasing the sprags 4, a ribbon spring 10 is used that is annularly formed by joining the ends of a strip member, but even when an elastic member that is annularly molded in advance using a metal or a resin is used as means for biasing the sprags 4, certain effects can be expected by including the dummy sprag-receiving holes 12.

In this invention, the sprag one-way clutch may include both of the retainers 5 having the dummy pockets 7 and the elastic member having the dummy sprag-receiving holes 12 to exert the above described effects, but the retainers 5 having the dummy pockets 7 alone or the elastic member having the dummy sprag-receiving holes 12 alone also may exert the above described effects.

In other words, for example, it is possible to adopt a sprag one-way clutch in which the retainers 5 having the dummy pockets 7 are used and an elastic member not having the dummy sprag-receiving holes 12 is used. Further, it is possible to adopt a sprag one-way clutch which includes a biasing means comprising the ribbon spring 10 or another elastic member and having the dummy sprag housing holes 12, and retainers 5 not having the dummy pockets 7.

### DESCRIPTION OF REFERENCE NUMERALS

1 Clutch (sprag one-way clutch)
2 Outer ring
3 Inner ring
4 Sprag
5 Retainer
5a Outer retainer
5b Inner retainer
6a,6b Pocket
7a,7b Dummy pocket
8a,8b Longitudinally extending portion (annular end portion)
9a,9b Pillar
10 Ribbon spring (elastic member)
11 Sprag-receiving hole
12 Dummy sprag-receiving hole
13 Tongue
14 Longitudinal member (annular section)
15 Pillar
w1,w2 Junction

1. A retainer for use in a one-way clutch comprising sprags disposed in an annular space between an outer ring and an inner ring,
wherein
the retainer has sprag-receiving pockets arranged along a circumferential direction, and configured to receive the sprags, the sprag-receiving pockets being equal in number to a number of the sprags; and dummy pockets comprising holes that are each open at radially outer and radially inner ends thereof, and disposed between respective circumferentially adjacent pairs of the sprag-receiving pockets.

2. A combination of two retainers each comprising the retainer of claim 1, wherein one of the two retainers is an outer retainer positioned in a radially outer portion of the annular space, and the other of the two retainers is an inner retainer positioned in a radially inner portion of the annular space.

3. The retainer of claim 1, wherein the retainer has a junction formed by joining together two circumferential ends of a strip member to form the retainer.

4. The retainer of claim 1, wherein the dummy pockets have areas smaller than areas of the sprag-receiving pockets.

5. An elastic member for use in a one-way clutch comprising sprags disposed in an annular space between an outer ring and an inner ring, the elastic member being configured to bias the sprags,
wherein
the elastic member has sprag-receiving holes arranged along a circumferential direction, and configured to receive the sprags, the sprag-receiving holes being equal in number to a number of the sprags; and dummy sprag-receiving holes comprising holes that are each open at radially outer and radially inner ends thereof, and disposed between respective circumferentially adjacent pairs of the sprag-receiving holes.

6. The elastic member of claim 5, wherein the dummy sprag-receiving holes have areas smaller than areas of the sprag-receiving holes.

7. A sprag one-way clutch including the retainer of claim 1, and used in a torque converter of an automatic transmission.

8. A sprag one-way clutch including the elastic member of claim 5, and used in a torque converter of an automatic transmission.

9. The combination of two retainers of claim 2, wherein each of the two retainers has a junction formed by joining together two circumferential ends of a strip member to form the retainer.

10. The combination of two retainers of claim 2, wherein the dummy pockets have areas smaller than areas of the sprag-receiving pockets.

11. The retainer of claim 3, wherein the dummy pockets have areas smaller than areas of the sprag-receiving pockets.

12. A sprag one-way clutch including the two retainers of claim 2, and used in a torque converter of an automatic transmission.

13. A sprag one-way clutch including the retainer of claim 3, and used in a torque converter of an automatic transmission.

14. A sprag one-way clutch including the retainer of claim 4, and used in a torque converter of an automatic transmission.

15. A sprag one-way clutch including the elastic member of claim 6, and used in a torque converter of an automatic transmission.
